(19) United States
(12) Patent Application Publication
(10) Pub. No.: US 2012/0151187 A1
(43) Pub. Date: Jun. 14, 2012

(54) INSTRUCTION OPTIMIZATION

(75) Inventors: Bart De Smet, Bellevue, WA (US); Henricus Johannes Maria Meijer, Mercer Island, WA (US)

(73) Assignee: MICROSOFT CORPORATION, Redmond, WA (US)

(21) Appl. No.: 12/966,536

(22) Filed: Dec. 13, 2010

(51) Int. Cl. G06F 9/30

(52) U.S. Cl. 712/220; 712/E09.016

(57) ABSTRACT

Programs can be optimized at runtime prior to execution to enhance performance. Program instructions/operations designated for execution can be recorded and subsequently optimized at runtime prior to execution, for instance by performing transformations on the instructions. For example, such optimization can remove, reorder, and/or combine instructions, among other things.

### BACKGROUND

Computer programs are groups of instructions that describe operations, or in other words actions, to be performed by a computer or other processor-based device. When a computer program is loaded and executed on computer hardware, the computer will behave in a predetermined manner by following the instructions of the computer program. Accordingly, the computer becomes a specialized machine that performs tasks prescribed by the instructions.

A programmer using one or more programming languages creates the instructions comprising a computer program. Typically, source code is specified or edited by a programmer manually and/or with help of an integrated development environment (IDE) comprising numerous development services (e.g., editor, debugger, auto fill, intelligent assistance . . . ). By way of example, a programmer may choose to implement source code utilizing an object-oriented programming language (e.g., C#®, Visual Basic®, Java . . . ) where programmatic logic is specified as interactions between instances of classes or objects, among other things. Subsequently, the source code can be compiled or otherwise transformed to another form to facilitate execution by a computer or like device.

A compiler conventionally produces code for a specific target from source code. For example, some compilers transform source code into native code for execution by a specific machine. Other compilers generate intermediate code from source code, where this intermediate code is subsequently interpreted dynamically at runtime or compiled just-in-time (JIT) to facilitate execution across computer platforms, for instance. Typically, most optimization of a program is performed at compile time when a source code is compiled to native or intermediate code. However, limited program optimization can also be performed at runtime during code interpretation or JIT compilation.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to instruction optimization. More particularly, rather than eagerly executing program instructions at runtime, execution can be delayed and the instructions can be recorded. Subsequently or concurrently, the recorded instructions can be optimized utilizing local and/or global optimization techniques. For example, instructions can be removed, reordered, and/or combined based on other recorded instructions. When instructions need to be executed, for instance to supply a result, an optimized group of instructions, which is not worse than an original group of instructions in terms of some metric (e.g., time to run, amount of memory . . . ), is executed.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an instruction optimization system.

FIG. 2 is a block diagram of a representative optimization component.

FIG. 3 is a block diagram illustrating composition of instruction optimization systems.

FIG. 4 graphically depicts query operators encoded as types.

FIG. 5 is a flow chart diagram of a method of instruction optimization.

FIG. 6 is a flow chart diagram of a method of enabling runtime instruction optimization.

FIG. 7 is a schematic block diagram illustrating a suitable operating environment for aspects of the subject disclosure.

### DETAILED DESCRIPTION

Details below are generally directed toward instruction optimization. Instructions can be recorded and transformed at runtime, prior to execution, to enhance execution of operations prescribed thereby. Such a transformation can involve removing, reordering, and/or combining instructions. In other words, execution can be delayed by recording operations that need to be performed and optimizing the operations prior to execution rather than immediately performing operations. This can be termed just-in-time instruction optimization. Further, such functionality can correspond to instruction virtualization since a layer of indirection is included with respect to specified instructions and instructions that are actually executed. In accordance with one embodiment, optimization can be performed locally, over a small set of instructions (e.g., peephole or window). Additionally or alternatively, a larger, or more global, optimization approach can be employed.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

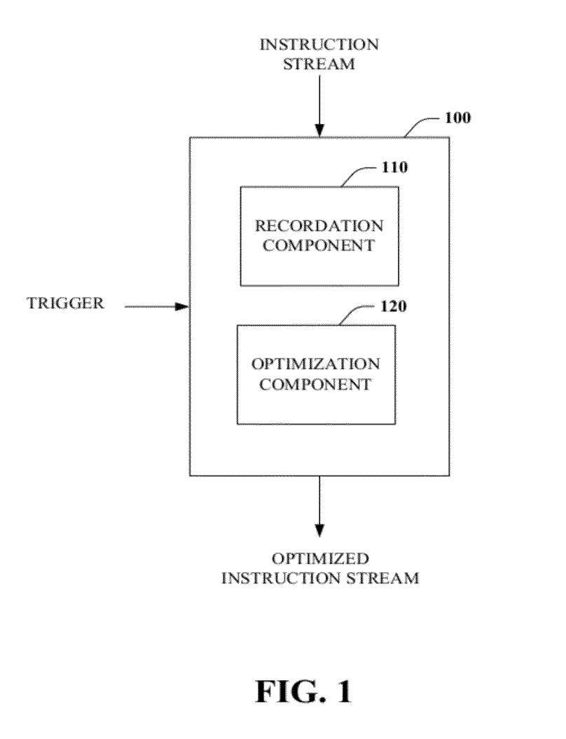

Referring initially to FIG. 1, an instruction optimization system 100 is illustrated. As shown, the instruction optimization system 100 receives, retrieves or otherwise obtains or acquires instructions, or in other words an instruction stream (a.k.a. stream of instructions), and outputs an optimize instruction stream. Such optimization can be performed at runtime prior to execution and be initiated by an internal or external trigger. Further, the instruction optimization system includes a recordation component 110 and an optimization component 120.

The recordation component 110 can receive, retrieve, or otherwise obtain or acquire an instruction stream, or in other words, a series of instructions that specifies one or more actions be performed, and record those instructions as they are acquired, for example. In some sense, a buffer of instructions is created where instructions are recorded and not executed. The instructions can be recorded on any computer-readable medium.

The optimization component 120 can transform recorded instructions into an optimized form, for instance as a function of algebraic properties, among other things (e.g., domain specific information, cost . . . ). As previously mentioned, optimization can be triggered by an internal or external trigger or event. By way of example and not limitation, the optimization can be triggered upon recording of a determined number of instructions and/or upon a request for a result that the instructions produce. Upon occurrence of one or more trigger events, the optimization component 120 can transform the recorded instructions into a better form to facilitate optimized execution of actions specified thereby.

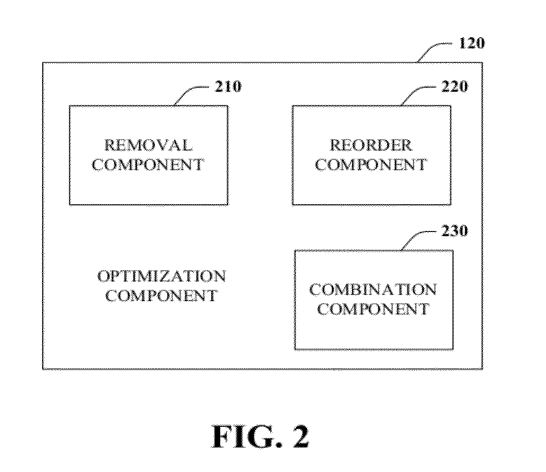

Turning attention to FIG. 2 a representative optimization component 120 is depicted. The optimization component 120 can comprise a number of sub-components that perform optimization operations including but not limited to a removal component 210, a reorder component 220, and a combination component 230. The removal component 210 can remove or delete an instruction. For example, if there is an instruction to add an element to a list and then remove the same element from the list, the removal component 210 can remove both of the instructions since the actions cancel out.

The reorder component 220 can reorder instructions to optimize computation. In other words, there may be computational costs associated with instruction set permutations that the reorder component 220 can seek to minimize. For example, execution can be improved by filtering a data set prior to performing some action since the data set will likely be reduced by the filtering. More particularly, if instructions indicate that order operation (e.g., OrderBy) is to be performed prior to a filter operation (e.g. Where), the instructions can be reversed so that the filter operation is performed before the order operation so that the order operation is executed with respect to a potentially reduced data set.

The combination component 230 can combine or, in other words coalesce, two or more instructions into a single instruction. More specifically, a new instruction can be generated that captures multiple instructions and the other instructions can be removed. For instance, rather than performing multiple filter operations requiring a data set to be traversed multiple times, the filter operations can be combined such that the data set need only be traversed once.

Returning to FIG. 1, the instruction optimization system 100 can operate at runtime prior to execution. Rather than executing instructions immediately, execution can be delayed and instructions can be recorded and optimized. To aid clarity and understanding, consider the following analogy. Suppose three dollar-amounts are to be added together by an individual (e.g., human), such as $2.50, $0.25, and $1.50. The individual could simply add the amounts together as they are provided (e.g., $2.50+$0.25=$2.75, $2.75+$1.50=$4.25). However, the computation can be made easier by delaying computation until all values to be added together are acquired, reordering the values, and then performing the computation. In particular, it is often easier for people to add with respect to half dollars (e.g., $0.50) than other fractions of dollars (e.g., $0.75, $0.25 . . . ). Accordingly, rather than performing addition on the amounts as they are seen, the values can simply be recorded. Subsequently, the amounts can be reordered to $2.50, $1.50, and $0.25 and computed (e.g., $2.50+$1.50=$4.00, $4.00+$0.25=$4.25). The same result is obtained but in a manner that is easier to compute. The instruction optimization system 100 can provide similar functionality with respect to any machine executable instructions.

Optimization, by way of the optimization component 120, can also be performed at various levels of granularity. In accordance with one embodiment, optimization can be performed with respect to a small set of instructions (e.g., peephole, window). For example, optimization can be triggered after each instruction is acquired with respect to a previous “N” adjacent instructions where “N” is a positive integer. Additionally or alternatively, a more global approach can be taken where optimization is performed on a large set of instructions. For instance, the optimization can be initiated just prior to execution, such as when a result produced as a function of the recorded instruction is requested. In one embodiment, simpler optimizations can be designated for performance with a small set of instructions whereas more complex optimizations can be designated for performance with respect to a larger set of instructions to leverage the aggregate knowledge regarding the instructions. Of course, this is not required. In fact, optimization can be very configurable such that one can designate which optimizations to perform and when they should be performed.

The functionality provided by the instruction optimization system 100 can be implemented in a variety of different ways. In one instance, dynamic dispatch can be utilized where the result of an operation exposes an object with specialized behavior for consecutive operations (e.g., virtual methods). Similarly, a state machine can be employed wherein acquisition of additional knowledge by way of instructions moves from one node to another as a function of the knowledge, or in other words, state. Of course, these are but two implementation mechanisms that are contemplated. Other implementations are also possible and will be apparent to one of skill in the art.

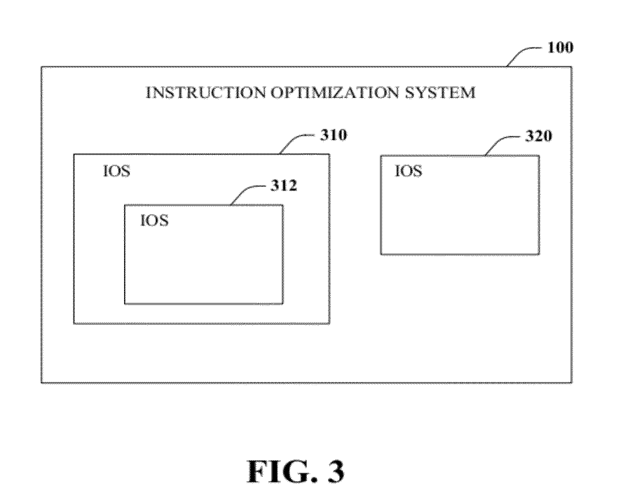

The instruction optimization system 100 can be employed alone or in combination with other instruction optimization systems. More specifically, an instruction optimization system 100 can include a number or instruction optimization sub-systems. As illustrated in FIG. 3, the instruction optimization system 100 can include two other instruction optimization sub-systems 310 and 320. The instruction optimization system 100 can delegate instructions to the sub-systems 310 and 320 to enable parallel processing of instruction streams, for example. Further, the instruction optimization sub-system 310 can delegate instruction optimization to yet another instruction optimization sub-system 312. In other words, instruction optimization systems are compositional and accordingly support parallel as well as recursive processing, among other things.

By way of example, and not limitation, instructions can relate to graphics or more specifically rendering a polygon. Instructions fed into the instruction optimization system 100 can be divided and distributed to instruction optimization sub-systems 310 and 320, which can render triangles, for instance. Accordingly, the execution of render polygon has been virtualized since it is divided into simpler things or multiple triangles can be rendered to form a polygon. Furthermore, optimization can occur if it can be determined that two polygons overlap, which can result in optimal rending of only one polygon.

In accordance with one exemplary embodiment, the optimization can be performed with respect to query instructions, or operators, comprising a query expression, for instance, such as but not limited to language-integrated query (LINQ) expressions. Query expressions specified in higher-level languages, such as C#® and Visual Basic®, can benefit from optimization strategies that work independently from a back-end query language (e.g., Transact SQL) that is targeted through query providers.

At a local level, optimization can be carried out on query operators, which are represented as methods that implement the functionality of a named operator (e.g., Select, Where . . . ). Furthermore, semantic properties of query operators can be exploited to aid optimization. Consider the following query expression:
from x in xs where x % 2==0 where x % 3==0 select x+1
   This query expression turns into three query operator method calls (e.g., Where, Where, Select). A naïve implementation of those operators would result in creation and execution of three iterators. All of those iterate over the source sequence separately, two carrying out a filter (e.g., using an if-statement) and another carrying out a projection (e.g., by yielding the result of invoking the selector function “x+1”). To optimize this expression, the “where” filters can be combined and the projection “select” can be carried out as part of the same iterator code as follows:
foreach (var x in xs) if (x % 2==0 && x % 3==0) yield return x+1;
   Even though these optimizations work, much more local optimizations can be made on the level of query operators.

Note that the ability to compose queries can easily lead to suboptimal queries. In particular, one can write nested query expressions in an indirect manner, much like creation of views in database products:
var productsInStock=from p in products where p.IsInStock select p;
var cheapProducts=from p in productsInStock where p.Price<100 orderby p.Price select p;
var discountTopToys=(from p in cheapProducts orderby p.Price descending select p) .Take(10);
   Since queries are first-class objects that can be passed around, queries like the above can reside in different places, resulting in adjacent query operator uses that are not immediately apparent. For example, in the above “cheapProducts” established an ascending order over price while “discountTopToys” applies another ordering, effectively making the previous ordering redundant.

Appendix A provides a few exemplary properties that hold at least for query operators. For the most part these properties enable local optimization based thereon and often enable two operators to be collapsed into a one operator. These and other optimizations can be realized by using virtual dispatch mechanisms where the result of a sequence operator exposes an object with specialized behavior for consecutive sequence operator applications. For example, the below sample code illustrates how the result of an “OrderBy” call reacts to a “Where” and “OrderBy” operations immediately following the call:

class OrderedSequence<T, K> : Sequence<T>

{

private Func<T, K> _keySelector;
internal OrderedSequence(Sequence<T> left, Func<T, K>
keySelector) : base(left)
{

_keySelector = keySelector;

}
public override Sequence<T> Where(Func<T, bool> filter)
{

return new OrderedSequence<T, K>(new

FilteredSequence<T>(_left, filter), _keySelector);

}
public override Sequence<T> OrderBy<K2>(Func<T, K2>

keySelector)

{

return new OrderedSequence<T, K2>(_left, keySelector);

}
public override IEnumerable<T> Source
{

get { return _left.Source.OrderBy(_keySelector); }

}

}

Each of those operators overrides a virtual method on the base class, “Sequence<T>:”

abstract class Sequence<T> : IEnumerable<T>

{

private Sequence<T> _left;
protected Sequence(Sequence<T> left)
{

_left = left;

}
public abstract IEnumerable<T> Source { get; }
public virtual Sequence<T> Where(Func<T, bool> filter)
{

return new FilteredSequence<T>(this, filter);

}
public virtual OrderedSequence<T, K> OrderBy<K>(Func<T,

K> keySelector)

{

return new OrderedSequence<T, K>(this, keySelector);

}
...

}

Sequence objects keep their left-side sequence object (e.g., what the operator represented by the type is being applied to). Subclasses can override the virtual query operator methods provided in order to do a local optimization. “Sequence<T>” implements “IEnumerable<T>,” whose implementation is provided by means of an abstract property called “Source.” In here, the sequence operations can be rewritten in terms of LINQ queries. Different strategies exist with respect to creating those “Sequence<T>” objects. For example, “Sequence<T>” objects can be utilized internally to existing “IEnumerable<T>” extension methods or a user can be allowed to explicitly move into a world of “optimized sequences,” for instance utilizing an extension method on “IEnumerable<T>.”

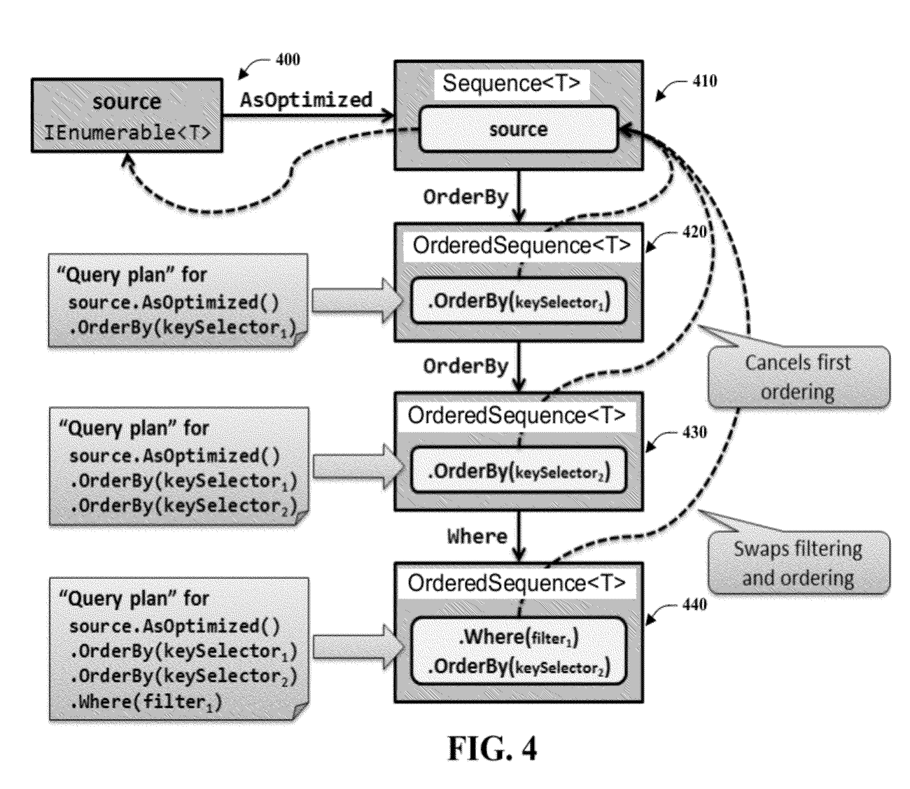

FIG. 4 graphically depicts how operators can be encoded as types and how the underlying “IEnumerable<T>” object adapts to reflect optimizations for the query operators being invoked. The sample illustrates use of “OrderBy” and “Where” clauses:
from x in source orderby k1 orderby k2 where f1 select x
   This query expression is turned into:
from x in source where f1 orderby k2 select x

More specifically, at query execution time, the “source” 400 is encapsulated by an optimized version thereof namely “Sequence<T>” 410. Operations with respect to data can now be executed with respect to “Sequence<T>” 410 utilizing methods that override virtual methods of the base class “Sequence<T> 410. When the first operator of the query expression “OrderBy” is seen an object “OrderedSequence<T>” 420 is produced that captures the “OrderBy” query operator with respect to a first key selector “k1.” When the second “OrderBy” operator is seen with respect to a second key selector “k2,” another “OrderedSequence<T>” object 430 cancels the first ordering and replaces it with the second ordering. In other words, the query execution plan for two “OrderBy” operations includes solely the latest “OrderBy” operation, since the first ordering can be cancelled as redundant. Subsequently, upon identifying the “where” operator the “OrderedSequence<T>” 440 can swap the ordering of the filter and ordering to potentially limit the data set prior to performing the ordering. Stated differently, the query plan for two “OrderBy” operations followed by a “Where” is the “Where” operator followed by the second “OrderBy” operation.

Note that the optimizations can be carried out at query construction/formulation time (e.g., after compilation but before execution) as a result of calling query operator methods. This technique can be used for various querying application-programming interfaces (APIs) underneath not just “IEnumerable<T>.” In particular, the “Sequence<T>” layer is an abstraction over the rewrite of operations and their relative ordering. Simply substituting the “Source” property type for another type that supports similar operators will suffice to rewrite operations applied to it. For example, this technique can be used to optimize query operators over IEnumerable<T>” or “IObservable<T>,” or their respective homo-iconic “IQueryable<T>” and “IQbservable<T>” forms. For the later forms, an underlying query provider will be provided with a pre-optimized query in terms of high-level querying operations.

To illustrate the generic nature of the rewriting mechanism, a similar set of types isomorphic to “System. String” operations can be built, for example to eliminate conflicting operations (e.g., those that can be canceled out):

abstract class OptimizedString
/*ideally it would be exposed as a string, but that type is sealed*/

{

protected OptimizedString _left;
protected Sequence(OptimizedString left)
{

_left = left;

}
public virtual OptimizedString ToLower( )
{

return new CaseChangingString(this, false /* lower */);

}
public virtual OptimizedString ToUpper( )
{

return new CaseChangingString(this, true /* upper */);

}

}
class OptimizedStringSource : OptimizedString
{

private string _s;
public OptimizedStringSource(string s)

: base(null /* no left-hand side */)

{

_s = s;

}
public override string ToString( )
{

return _s;

}

}
class CaseChangingString : OptimizedString
{

private bool _upper;
internal CaseChangingString(OptimizedString left, bool upper)

: base(left)

{

_upper = upper;

}
public virtual OptimizedString ToLower( )
{

return new CaseChangingString(_left, false /* lower */);

// Here “this” is discarded and ToLower is wired to the left-hand
side.

}
public virtual OptimizedString ToUpper( )
{

return new CaseChangingString(_left, true /* upper */);

// Here “this” is discarded and ToUpper is wired to the left-hand
side.

}
public override string ToString( )
{

return _upper ? _left.ToUpper( ) : _left.ToLower( ); // If

asked to provide the string, the operation is initiated.

}

}

In fact, the general pattern is to have a lazy operation that triggers the optimized computation. In the above “String” example, it is “ToUpper.” In the case of “Sequence<T>” enumeration of the “Source” property triggers the optimized computation.

Furthermore, the subject optimization mechanisms are beneficial for any immutable type. The problem with immutable types is whenever something needs to be done that corresponds to a mutation, or change, a new “thing” (e.g., object, element . . . ) needs to be created. For example, there can be many instructions pertaining to creating a new thing, deleting the thing, and creating a new thing. Instead of performing several allocations and de-allocations with respect to an immutable thing, all mutations can be recorded and later utilized to create only a single new immutable thing capturing all the mutations up to the point of allocation.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the instruction optimization system 100 can employ such mechanism to determine or infer optimizations, for example as a function of history or context information.

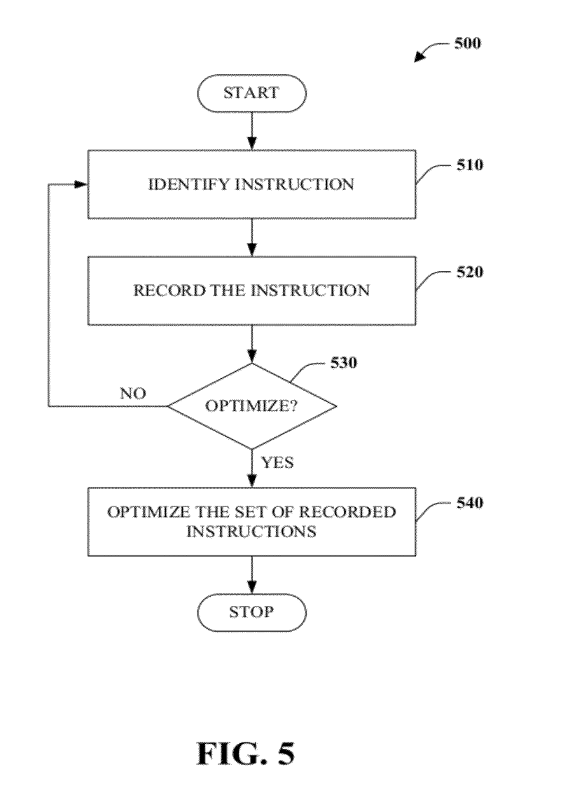

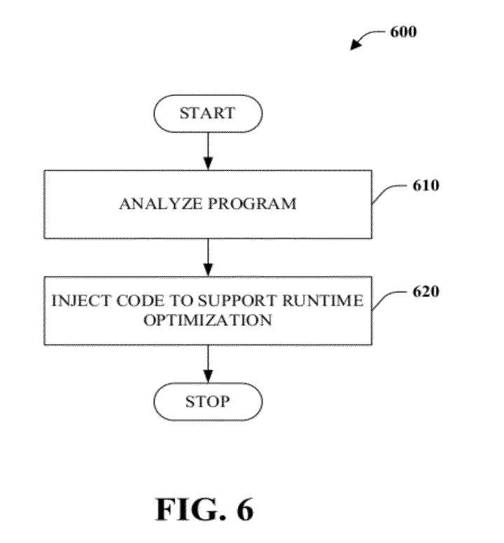

In view of the exemplary systems described supra, methodologies that may be implemented in accordance with the disclosed subject matter will be better appreciated with reference to the flow charts of FIGS. 5-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method that facilitates instruction optimization 500 is illustrated. At reference numeral 510, an instruction is identified, received, retrieved or otherwise obtained or acquired. At numeral 520, the identified instruction is recorded or in other words noted in some manner without executing the instruction. A determination is made at reference numeral 530 as to whether optimization should be performed with respect to an instruction set. Such a determination can be made as a function of an internal or external trigger. An example, of an internal trigger can be identification of a particular number of instructions (e.g., optimize after identification of every instruction, optimize after identification of every three instructions . . . ). An external trigger can correspond to a request for data that the instructions or more specifically operations specified by the instructions produce or manipulate, for instance. If it is determined that optimization should be performed (“YES”), the method 500 continues at reference numeral 540 where the set of recorded instructions is optimized. If, however, optimization is not desired (“NO”), the method can proceed to reference numeral 510 where another instruction is identified. It is to be appreciated that the method 500 can be lazy. In other words, instructions can continue to be collected and form part of a collective knowledge that can be utilized with respect to optimization until execution is required, for example to produce a result, rather than simply eagerly executing instructions as they are identified. Accordingly, the method 500 can be said to perform just-in-time instruction optimization.

To facilitate clarity and understanding regarding aspects of the claimed subject matter consider the following real-world analogy. Suppose a homeowner instructs a contractor to paint his house and install new windows while the homeowner is on vacation for two weeks. The contractor can eagerly paint the house and install the new windows the next day. Alternatively, the contractor can simply note that the house is to be painted and new windows are to be installed, and just before the homeowner returns from vacation, perform all the work. In other words, the contractor can virtualize the instructions. Although, the homeowner may think that the work will commence shortly after the instruction, there is no difference to the homeowner as to when the work is performed (e.g., as well as how and by whom the work is performed). However, the efficiency with which the work is performed can be optimized in the later case. For example, suppose the homeowner calls midway through his vacation and changes the paint color of the house. If the contractor already painted the house, he would have to re-paint the house in the new color—twice the work. However, if he had not yet begun, he could just change the color previously noted and utilize the new color when he paints the house the first and only time. Further, suppose the homeowner adds an additional task such as fix the roof If the contractor already performed the work, he has likely removed all his tools from the job site and thus would have to bring them back to fix the roof However, if the contractor performed work lazily, he could simply note add the task to his list. The contractor can then wait until just before the homeowner returns from vacation to complete all the work. Of course, if the homeowner decides to come home early, this could also trigger the contractor to complete all the tasks on the list. Still further yet, it is to be appreciated that the contractor need not complete all tasks himself, rather the contractor can delegate work one or more sub-contractors, who can perform similar lazy optimization.

FIG. 6 is a flow chart diagram of a method of enabling runtime instruction optimization 600. At reference numeral 610, a computer program can be analyzed. For example, source code can be analyzed during a compilation process. At reference numeral 620, code can be injected with respect to the program based on the analysis to support runtime optimization as previously described herein. For example, code can be injected into, or linked to, the program that utilizes special types and virtual dispatch to implement optimization. Alternatively, code can be injected into, or linked to, the program that specifies a state machine that encodes optimization techniques, for instance based on algebraic properties. For example, a runtime library can be employed that modifies an existing instruction implementation.

As used herein, the terms “component,” “system,” and “engine” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

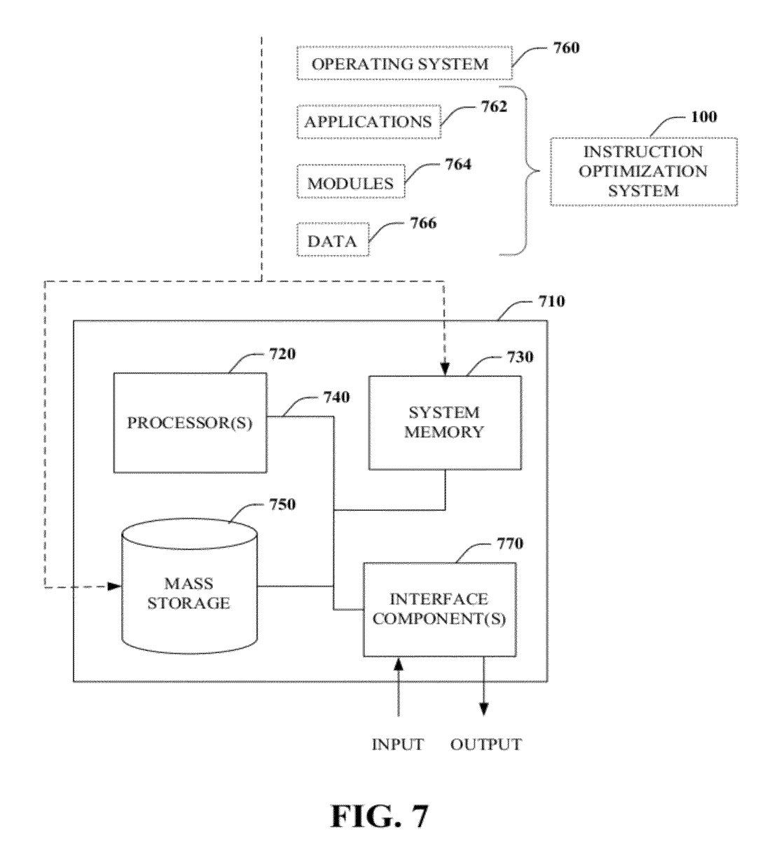

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 7, illustrated is an example general-purpose computer 710 or computing device (e.g., desktop, laptop, server, hand-held, programmable consumer or industrial electronics, set-top box, game system . . . ). The computer 710 includes one or more processor(s) 720, memory 730, system bus 740, mass storage 750, and one or more interface components 770. The system bus 740 communicatively couples at least the above system components. However, it is to be appreciated that in its simplest form the computer 710 can include one or more processors 720 coupled to memory 730 that execute various computer executable actions, instructions, and or components stored in memory 730.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration.

The computer 710 can include or otherwise interact with a variety of computer-readable media to facilitate control of the computer 710 to implement one or more aspects of the claimed subject matter. The computer-readable media can be any available media that can be accessed by the computer 710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 730 and mass storage 750 are examples of computer-readable storage media. Depending on the exact configuration and type of computing device, memory 730 may be volatile (e.g., RAM), non-volatile (e.g., ROM, flash memory . . . ) or some combination of the two. By way of example, the basic input/output system (BIOS), including basic routines to transfer information between elements within the computer 710, such as during start-up, can be stored in nonvolatile memory, while volatile memory can act as external cache memory to facilitate processing by the processor(s) 720, among other things.

Mass storage 750 includes removable/non-removable, volatile/non-volatile computer storage media for storage of large amounts of data relative to the memory 730. For example, mass storage 750 includes, but is not limited to, one or more devices such as a magnetic or optical disk drive, floppy disk drive, flash memory, solid-state drive, or memory stick.

Memory 730 and mass storage 750 can include, or have stored therein, operating system 760, one or more applications 762, one or more program modules 764, and data 766. The operating system 760 acts to control and allocate resources of the computer 710. Applications 762 include one or both of system and application software and can exploit management of resources by the operating system 760 through program modules 764 and data 766 stored in memory 730 and/or mass storage 750 to perform one or more actions. Accordingly, applications 762 can turn a general-purpose computer 710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the instruction optimization system 100, or portions thereof, can be, or form part, of an application 762, and include one or more modules 764 and data 766 stored in memory and/or mass storage 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the instruction optimization system 100 and/or associated functionality can be embedded within hardware in a SOC architecture.

The computer 710 also includes one or more interface components 770 that are communicatively coupled to the system bus 740 and facilitate interaction with the computer 710. By way of example, the interface component 770 can be a port (e.g., serial, parallel, PCMCIA, USB, FireWire . . . ) or an interface card (e.g., sound, video . . . ) or the like. In one example implementation, the interface component 770 can be embodied as a user input/output interface to enable a user to enter commands and information into the computer 710 through one or more input devices (e.g., pointing device such as a mouse, trackball, stylus, touch pad, keyboard, microphone, joystick, game pad, satellite dish, scanner, camera, other computer . . . ). In another example implementation, the interface component 770 can be embodied as an output peripheral interface to supply output to displays (e.g., CRT, LCD, plasma . . . ), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

### APPENDIX A

Adjacent where filters: xs.Where(f₁).Where(f₂)==xs.Where(x=>f₁(x) && f₂(x))
   Also for derived operators like OfType
Adjacent select projections: xs.Select(p₁).Select(p₂)==xs.Select(x=>p₂(p₁(x))
   Also for derived operators like Cast
   Similar for Zip, assuming n-ary selector overloads are present
Idempotency of distinct: xs.Distinct( )Distinct( )==xs.Distinct( )
Cancellation of redundant orderings: xs. OrderBy(kᵢ){.ThenBy( . . . )}*.OrderBy(k₂)==xs.OrderBy(k₂)
   Same holds for uses of the descending variants of those operators.
Commutativity of ordering and filtering: xs.OrderBy(k₁).Where(f₁)==xs.Where(f₁).OrderBy(k₁)
   Rationale: it's cheaper to order a reduced sequence
N-ary operator restoration:
   xs.Concat(ys)==EnumerableEx.Concat(xs, ys)
   EnumerableEx.Concat(xs, ys).Concat(zs)==EnumerableEx.Concat(xs, ys, zs)
   Also for similar operators with associative properties, like Union
Propagation of arity:
   Enumerable.Empty( )composed with various operators stays Empty
   Similar remarks hold for Return (e.g. with Select), Throw (unless followed by a Catch)
Elimination of cancelling operators:
   xs.Reverse( )Reverse( )==xs
   This only holds if the input sequence is not infinite
Skip and Take interactions (with m>=0, n>=0):
   xs.Take(m).Take(n)==xs.Take(Math.Min(m, n))
   xs.Take(m).Skip(n) (where m>n)==xs.Skip(n).Take(m−n)
   xs.Skip(m).Skip(n)==xs.Skip(m+n)
Reduction of intermediate allocations:
   xs.ToArray( )ToArray( )==xs.ToArray( )
   xs.ToList( )ToList( )==xs.ToList( )
   In general, a later .To* operator eliminates the need for a previous such .To* operator use.
Pushing intermediate allocations down:
   xs.To[Array|List]( )[Where|Select| . . . ]==xs.[Where|Select| . . . ].To[Array|List]( )
   This only holds if the input sequence is not infinite
Reverse and OrderBy change sorting direction:
   xs.OrderBy(k₁).Reverse( )==xs.OrderByDescending(k₁)
   xs.OrderByDescending(k₁).Reverse( )==xs.OrderBy(k₁)

What is claimed is:

1. A method of optimizing instructions, comprising:
employing at least one processor configured to execute computer-executable instructions stored in memory to perform the following acts:
recording a stream of instructions designated for execution; and
optimizing the stream of instructions at runtime prior to execution.

2. The method of claim 1, optimizing the stream of instructions incrementally upon addition of an instruction to the stream of instructions.

3. The method of claim 2, optimizing the stream of instructions globally.

4. The method of claim 1, optimizing the stream of instructions globally.

5. The method of claim 1 further comprising initiating the optimizing as a function of an external trigger.

6. The method of claim 1 further comprising recursively recording and optimizing the stream.

7. The method of claim 1 further comprising recording and optimizing portions of the stream in parallel.

8. The method of claim 1, recording a stream of instructions specifying query operations.

9. An instruction optimization system, comprising:
a processor coupled to a memory, the processor configured to execute the following computer-executable components stored in the memory:
a first component configured to record instructions designated for execution; and
a second component configured to optimize the instructions, wherein the first and second component operate at runtime prior to instruction execution.

10. The system of claim 9, the second component is configured to optimize the instructions incrementally upon recordation of an instruction.

11. The system of claim 10, the second component is configured to optimize the instructions globally.

12. The system of claim 9, the second component is configured to optimize the instructions globally when one or more of the instructions are about to be executed.

13. The system of claim 9, the second component is configured to optimize the instructions as a function of an external trigger.

14. The system of claim 9, further comprising a second instruction optimization system.

15. The system of claim 9, at least one of the first component or the second component is implemented by way of virtual dispatch.

16. The system of claim 9, at least one of the first component or the second component is implemented by way of a state machine.

17. The system of claim 9, the instructions correspond to query operators.

18. A computer-readable storage medium having instructions stored thereon that enables at least one processor to perform the following acts:
recording instructions designated for execution; and
optimizing the instructions incrementally, at runtime, and prior to execution as a function of one or more algebraic properties.

19. The computer-readable storage medium of claim 18, further comprising optimizing a set of the instructions.

20. The computer-readable storage medium of claim 18, employing virtual dispatch to perform the recording and the optimizing.
